(19) United States
(12) Patent Application Publication
(10) Pub. No.: US 2008/0286880 A1
(43) Pub. Date: Nov. 20, 2008

(54) Methods and Systems for Nanoparticle Enhancement of Signals

(75) Inventors: Samer Al-Murrani, Topeka, KS (US); Stephen J. Fonash, State College, PA (US); Matthew R. Henry, Mechanicsburg, PA (US); Ali Kaan Kalkan, State College, PA (US); Daniel Krissinger, Harrisburg, PA (US); Terry Rager, Wernersville, PA (US)

Correspondence Address: BURNS & LEVINSON, LLP, 125 SUMMER STREET, BOSTON, MA, 02110, US

(73) Assignee: The Penn State Research Foundation, University Park, PA (US)

(21) Appl. No.: 11/571,642

(22) PCT Filed: Jul. 5, 2005
(86) PCT No.: PCT/US05/23859

§ 371 Date: Apr. 10, 2007

Related U.S. Application Data
(60) Provisional application No. 60/585,905, filed on Jul. 7, 2004.

(51) Int. Cl. G01N 21/75

(52) U.S. Cl. 436/166

(57) ABSTRACT

Methods and systems for utilizing metal nanoparticles to enhance optical (UV, visible, and IR, as appropriate) signals from a reporting entity are presented. The methods and systems of this invention do not require the nanoparticles to be attached or adhered to a surface, assembled in a matrix or coated with a spacer coating.

### CROSS REFERENCE TO RELATED APPLICATIONS

This application claims priority U.S. Provisional Patent application Ser. No. 60/585,905, filed on Jul. 7, 2004, entitled METHODS AND SYSTEMS FOR NANOPARTICLE ENHANCEMENT OF SIGNALS, which is also incorporated by reference herein.

### BACKGROUND OF THE INVENTION

There are numerous applications in which entities, such as chemically attached (or incorporated) labels, tags, or other reporting entities, which generate a signal, are utilized. In many of those applications, the signal generation mechanism can be modified or enhanced by electromagnetic fields.

Among those applications, the use of nucleic acids (DNA or RNA) in research and in medicine represents an important application. Many diagnostic tests are based upon recognizing specific genetic sequences, and cloning. Probes with reporting entities are typically used in such tests and one of the most commonly applied reporting entities utilizes fluorescence.

Regarding the use of nucleic acids in research and in medicine, in the past most studies on the molecular mechanisms involved in how a cell would respond to change in the metabolic status or the overall physiological condition of the animal involved the painstaking study of a single gene or gene product to determine how it may influence the biological response observed. To a large extent these studies failed to take into account the fact that in order to respond to a change in conditions the cell usually coordinates the expression and activities of tens, hundreds, or even thousands of genes and gene products.

The advent of techniques in the mid 1990s that allow the study of thousands of genes and gene products such as microarrays (DNA and protein arrays) and advancements in mass spectrometry based technologies have allowed studies to be conducted that moved beyond the classical single gene research. The study of thousands of gene products all at the same time gives a complete picture as to what is happening in the cell at the molecular level at any given moment, therefore, allowing the visualization of how single genes fall into networks of genes that eventually orchestrate the observed function of the cell. Such studies give a better overall understanding of the mechanisms that may be involved in generating the observed cellular response and therefore the response of the animal as a whole.

DNA Microarrays, whether they are glass, plastic, membrane or Affymetrix® type arrays all use the same basic principal where a DNA sequence (cDNA or oligonucleotide) that corresponds to a particular gene is immobilized on a solid surface support. By repeating this process for all known and unknown sequences (such as, but not limited to, an EST-expressed sequence tag) the end result is a surface that contains thousands of sequences, each corresponding to a unique gene, that form an “array”.

As an example of an experiment, consider a protocol where leukemia patients that respond to treatment are compared to others that do not. One inquiry of interest is the molecular differences that account for the observed differences in response.

Considering the above example, blood samples are taken from all patients and the white blood cells are isolated and total RNA is extracted using standard protocols. The RNA is first tested for quality and quantity and then it is used in a reaction to produce cDNA or cRNA (for Affymetrix® chips, for example). The resultant cDNA or cRNA sample is also checked for quality and quantity and used in a labeling reaction. The labeling reactions will differ based on the type of array used and may be dual color fluorescent-based (glass slide arrays), single color biotin and avidin-based (such as, for example, Affymetrix® chips) or radioactivity-based (plastic and membrane arrays). Once the labeled cDNA or cRNA is obtained it is hybridized to the array or chip, the arrays or chips are then washed and scanned, light signals are generated and quantified based on how much complementary labeled DNA or RNA present in the probe sample bound to each spot on the microarray. The image file generated from each scanned array is then used to convert the signal intensities of each individual spot to numbers using specialized software supplied with the scanners and a data file is produced for each array that gives the information pertaining to how much signal was detected from each spot on the array, including levels of local background and other information.

For the dual color fluorescent-based arrays each of the samples that are being compared are labeled with a different fluorophor each with a different emission wavelength (e.g., Cy3 and Cy5 or Alexa® 555 and Alexa® 645). By measuring, for example, the difference between the red channel fluorescence (Alexa® 645 or Cy5) and the green channel fluorescence (Alexa® 555 or Cy3), the amount of a given gene transcript present in the mRNA from the non-responder leukemic patient group relative to the amount of that same gene transcript present in the mRNA from the responder leukemic patient group can be inferred.

Microarrays allow scientists to monitor the transcription, or expression levels, of thousands of genes in parallel fashion. Although this optical signal technology has revolutionized biological science and the way many experiments are conducted, it is important to note that its sensitivity could be enhanced further. With the current technology only genes that are present at medium or high levels of expression are detectible simply because these are the genes that have enough transcripts present at any given time to reach the signal detection threshold of most commercially available scanners. This means that genes that are expressed at low levels will go undetected; therefore, blinding researchers to what could be major contributors to the phenotype under study. Another related limitation is that often the amount of RNA that is available from different sources is insufficient for microarray analysis, such as when the use of Laser Capture Microdissection (LCM) is necessary, or when the source of RNA is a surgical biopsy. In these cases, users are forced to enzymatically amplify their RNA, which could lead to misrepresentation of the mRNAs present in the sample due to preferential transcription of certain target sequences through mechanisms that are not well understood.

Recent technological advances have been made whereby nanoparticles (NPs) composed of various metals are used to aid in the detection of biological molecules, either by serving as the agent conferring detection or by the enhancement of optical signals from other molecules. These applications include but are not limited to Raman and fluorescence assays. One of many potentially useful properties possessed by NPs is Surface Plasmon Resonance (SPR), whereby an electromagnetic near field is generated on and about the surface of the nanoparticles upon illumination with specific wavelengths of light. In the case of fluorescence, the interaction of this field with nearby fluorophores results in an enhancement of their fluorescent intensity. Applications that use NPs to directly or indirectly aid in the generation of microarray hybridization signal are also currently being developed. However, those applications currently available require investment in specialized scanning hardware and software and significant change to the microarray user's protocol (such as Invitrogen's RLS System), as exemplified by the use of nanoparticles as the reporting entity (the signal generating entity).

In one conventional application, metal nanoparticles are used to enhance the fluorescence of fluorophores by means of adsorption or attachment of such fluorophores onto metal nanoparticle-coated or nanotextured-metal surfaces. This approach requires manufacturing of pre-coated or pre-textured surfaces. Since optical signal quenching can result if a fluorophore is too close to a nanopartice, a spacer layer is used to prevent quenching of fluorescence by the nanoparticles. The adhesion of the metal to the underlying substrate as well as to the probed bio-molecules must be strong enough to avoid detachment of molecules/nanoparticles as well as to avoid nanoparticle aggregation during chemical processes such as the hybridization or the washing step in DNA microarrays. Furthermore, for larger molecules like DNA or proteins, the enhancement in fluorescence by this approach will be significant only at the point of contact on the substrate surface. These problems limit the use of nanoparticle-coated or metal-textured surfaces.

Therefore, a simple method for increasing the sensitivity of the microarray assays which enhances the detectable optical signal generated from each spot on the array and which does not require the NPs to be attached or adhered to a surface is needed. Such a method would be of great value.

### BRIEF SUMMARY OF THE INVENTION

Methods and systems for utilizing metal nanoparticles to enhance optical (UV, visible, and IR, as appropriate) signals from a reporting entity are presented. The methods and systems of this invention do not require the nanoparticles to be attached or adhered to a surface, assembled in a matrix or coated with a spacer coating.

The system of this invention includes one or more nanoparticles, one or more reporting entities, and, a molecule probe (also referred to as a detecting molecule) solution into which the reporting entities and the nanoparticles are incorporated; whereby the nanoparticles enhance a sensing function due to the reporting entities. Exemplary molecule probe solutions include, but are not limited to, DNA, RNA, or proteins in a solution.

For a better understanding of the present invention, together with other and further objects thereof, reference is made to the accompanying drawings and detailed description.

### BRIEF DESCRIPTION OF THE DRAWINGS

FIG. 1 (top panel) is a pictorial representation of the fluorescence observed in a conventional application;

FIG. 1 (middle panel) is a pictorial representation of the fluorescence enhancement observed with the use of 20 nm diameter Au particles added to the solution;

FIG. 1 (lower panel) is another pictorial representation of the fluorescence enhancement observed with the use of 20 nm diameter Au particles added to the solution;

FIG. 2 is another pictorial representation of the fluorescence observed with the use of Au and Ag nanoparticles of various diameters added to the solution either separately or in combination;

FIG. 3 is a pictorial representation of the fluorescence response obtained using fluorescently labeled Arabidopsis cDNA to probe a human oligonucleotide array;

FIG. 4 is a schematic graphical representation of the reaction mechanism for a reactive functionalized nanoparticle;

FIG. 5 (top panels) is a pictorial representation of the fluorescence enhancement observed with the use of non-reactive functionalized particles;

FIG. 5 (lower panels) is a pictorial representation of the fluorescence enhancement observed with the use of reactive functionalized particles of the same size as used in FIG. 5 (top panels);

FIG. 6 is a schematic pictorial representation of the reactive functionalized gold to fluorophore distance;

FIG. 7 is another pictorial representation of the fluorescence enhancement observed with the use of reactive functionalized particles;

FIG. 8 is another pictorial representation of the results of FIG. 7;

FIG. 9 is another pictorial representation of the results of FIG. 7;

FIG. 10 is a schematic pictorial representation of dUTP with two acceptor sites.

### DETAILED DESCRIPTION OF THE INVENTION

Methods and systems for utilizing metal nanoparticles to enhance signals from a reporting entity are disclosed herein below. The methods and systems of this invention do not require the nanoparticles to be attached or adhered to a surface, assembled in a matrix or coated with a spacer coating.

While the embodiments described below relate to DNA as the molecule under the test (which can be or can be modified to be the detecting molecule), it should be noted that the methods and systems of this invention also apply to other molecules under test, including but not limited to RNA, antibodies, enzymes, factors, cell membrane receptors, proteins or peptides. The molecule under test can be in active or inactive form. An “active form” molecule is in a form that can perform a biological function. An “inactive form” molecule is one that cannot perform a biological function. Usually, it can be processed either naturally or synthetically in order for the molecule to perform a biological function. Exemplary test molecules include, but are not limited to, nucleic acids, aromatic carbon ring structures, NADH, FAD, amino acids, carbohydrates, steroids, flavins, proteins, DNA, RNA, oligonucleotides, peptide nucleic acids, fatty acids, sugar groups such as glucose etc., vitamins, cofactors, purines, pyrimidines, formycin, lipids, phytochrome, phytofluor, peptides, lipids, antibodies and phycobiliproptein.

The metal nanoparticles used in the present invention can be spheroid, ellipsoid, or of any other geometry. Exemplary metals include, but are not limited to, rhenium, ruthenium, rhodium, palladium, silver, copper, osmium, iridium, platinum, and gold and combinations thereof. Although the nanoparticles used in the invention are referred to as metal nanoparticles, nanoparticles of any composition having a conductivity that will support the generation of surface plasmons (and their fields) such that signals from a reporting entity are enhanced can be used. Thus, “metal” as used herein refers to a composition having a conductivity that will support the generation of surface plasmons (and fields) such that signals from a reporting entity are enhanced. “Nanoparticles,” as used herein, refers to colloidal nanoparticles, non-colloidal nanoparticles, capped/terminated (e.g., citrate coated) nanoparticles, nanoparticles with organic groups attached to their outer surface for a bonding or spacing role (also referred herein as functionalized reactive nanoparticles) and other nanoparticles.

While the methods of this invention can be applied over a variety of particles and compounds (such as reporting entities) attached to DNA molecules and the like, one important application, but not limit, is the enhancement of fluorescence of fluorophores. Fluorophores are examples of reporting entities. Reporting entity, as used herein, refers to compounds or molecules (not genes) used to generate a labeling signal. The term “fluorophore” means any substance that emits electromagnetic energy (light) at a specific wavelength (emission wavelength) when the substance is illuminated by radiation of a different wavelength (excitation wavelength). Extrinsic fluorophores refers to structures where fluorophores are bound to another substance. Intrinsic fluorophores refer to substances that are fluorophores themselves. Exemplary fluorophores include but are not limited to Alexa Fluor® 350, Dansyl Chloride (DNS-Cl), 5-(iodoacetamida) fluoroscein (5-IAF); fluoroscein 5-isothiocyanate (FITC), tetramethylrhodamine 5-(and 6-)isothiocyanate (TRITC), 6-acryloyl-2-dimethylaminonaphthalene (acrylodan), 7-nitrobenzo-2-oxa-1,3,-diazol-4-yl chloride (NBD-Cl), ethidium bromide, Lucifer Yellow, 5-carboxyrhodamine 6G hydrochloride, Lissamine rhodamine B sulfonyl chloride, Texas Red™ sulfonyl chloride, BODIPY™, naphthalamine sulfonic acids including but not limited to 1-anilinonaphthalene-8-sulfonic acid (ANS) and 6-(p-toluidinyl)naphthalen-e-2-sulfonic acid (TNS), Anthroyl fatty acid, DPH, Parinaric acid, TMA-DPH, Fluorenyl fatty acid, Fluorescein-phosphatidylethanolamine, Texas red-phosphatidylethanolamine, Pyrenyl-phophatidylcholine, Fluorenyl-phosphotidylcholine, Merocyanine 540, 1-(3-sulfonatopropyl)-4-[-.beta.-[2[(di-n-butylamino)-6naphthyl]vinyl]pyridinium betaine (Naphtyl Styryl), 3,3′dipropylthiadicarbocyanine (diS-C.sub.3-(5)), 4-(p-dipentyl aminostyryl)-1-methylpyridinium (di-5-ASP), Cy-3 lodo Acetamide, Cy-5-N-Hydroxysuccinimide, Cy-7-Isothiocyanate, rhodamine 800, IR-125, Thiazole Orange, Azure B, Nile Blue, Al Phthalocyanine, Oxaxine 1, 4′,6-diamidino-2-phenylindole (DAPI), Hoechst 33342, TOTO, Acridine Orange, Ethidium Homodimer, N(ethoxycarbonylmethyl)-6-methoxyquinolinium (MQAE), Fura-2, Calcium Green, Carboxy SNARF-6, BAPTA, coumarin, phytofluors, Coronene, and metal-ligand complexes. Representative intrinsic fluorophores include but are not limited to organic compounds having aromatic ring structures including but not limited to NADH, FAD, tyrosine, tryptophan, purines, pyrirmidines, lipids, fatty acids, nucleic acids, nucleotides, nucleosides, amino acids, proteins, peptides, DNA, RNA, sugars, and vitamins. Additional suitable fluorophores include enzyme-cofactors; lanthanide, green fluorescent protein, yellow fluorescent protein, red fluorescent protein, blue fluorescent protein or mutants and derivates thereof. It must also be noted that in recent years there has been a growing interest in using quantum dots, typically semiconductor nanoparticles/nanocrystals, as fluorophores due to their superior emission and structural/chemical stability. This type of fluorophore is within the scope of this invention.

In addition to fluorescence, the labeling signal radiated by the reporting entity can also be produced by Raman scattering. Raman scattering is inelastic scattering of light from matter. In this process, the particles of light, which are photons, interact with the vibrational modes of a molecule. As a result of this interaction, photons either absorb (energy gain) or emit (energy loss) these vibrational modes. When the scattered light is analyzed by conventional methods, the scattered photon energy shows gains or losses at certain frequencies in the form of sharp peaks. In other words the scattered light's frequency is shifted from that of incident light. This change is termed the Raman shift. The frequency (or energy) of these sharp peaks (i.e., frequency shifts) corresponds to vibrational modes in the molecules causing the scattering. Since different molecules or materials have different vibrational modes at different energies, the Raman peaks are a characteristic of the molecule or material that scatters the light. Raman spectroscopy may also be used to identify (trace) the “labeling molecules” or “reporter molecules”. Tracing of the labeling molecules or reporter molecules from their Raman signal has advantages over tracing them from their fluorescence signal. Unlike fluorescence bands, Raman peaks are very sharp, so they are much easier to resolve when several different reporter molecules are used. Nearly three decades ago, it was shown that the enhanced near fields in the vicinity of metal nanostructures, as mentioned above, also enhance Raman scattering. This phenomenon is known as “surface-enhanced Raman scattering (SERS)”. In fact, in SERS, the change is much larger than it is in fluorescence. Enhancements on the order of 10¹⁵-10¹⁶ have been reported. SERS has been utilized for the direct detection of the probe molecules or in detecting molecules from their own Raman signal down to the single molecule detection limit. Here, we claim the enhancement of labeling Raman signal by the nanoparticle approaches disclosed in this invention. “The Raman scattering reporter entities of this invention can be chosen from organic or inorganic molecules, or semiconductor, polymer nanoparticles/nanocrystals. For optimum Raman signal (i.e., strongest), the absorption and emission energy of these Raman scattering reporter entities should match with the energy of the plasmon resonance in metal particles as well as the laser excitation (resonant Raman scattering)”. In general, fluorophores are usually good Raman scattering entities. In addition, quantum dots also have stable and very distinctive characteristic Raman signals.

In this invention, nanoparticles and reporting entities are incorporated into a molecule probe solution. The nanoparticles (NPs) enhance the signal arising from the reporting entity (e.g., fluorescence, Raman scattering). When detection is carried out, it may be advantageous that the probe molecules together with nanoparticles and reporting entities are all immobilized on a surface.

The present invention includes one or more nanoparticles (NPs), one or more reporting entities (in the embodiments shown below, dye molecules), and a detecting molecule (also referred to as a probe molecule) and a solution into which reporting entities and nanoparticles are incorporated. In this manner, the nanoparticles enhance a labeling signal (fluorescence, in the embodiments shown below, or Raman scattering) due to the reporting entities. In substantially all embodiments of the present invention, the nanoparticles are capable of being bound/incorporated to molecules in the detecting molecule solution. Each one of the reporting entities is bound/incorporated to a molecule in the detecting molecule solution. In substantially all embodiments of the present invention, one or more nanoparticles are capable of being bound/incorporated to the probe molecule in a location different from a location at which the reporting entity is bound/incorporated to the probe molecule in the detecting molecule solution. In general, the nanoparticles are bonded to the test (detecting) molecule by mechanisms including, but not limited to, Van der Waals, ionic, hydrogen, or covalent bonding.

One method aspect of the present invention includes incorporating nanoparticles and reporting entities into a detecting molecule solution. Several detailed embodiments are presented herein below in which the nanoparticles and the reporting entities are incorporated into the detecting molecule solution either separately or together and either at the same step or in different steps of the method.

In the embodiments described below, DNA is the molecule under test and fluorophores (also referred to as fluorescent tag molecules) are the reporting entities. In these embodiments, the metal nanoparticles cannot be directly attached to fluorescent tag molecules, since this will quench the fluorescence. However, the nanoparticles and tags can be separately attached to the DNA. In this manner, the density of particles and fluorophores attached to DNA can be controlled for optimizing the separation between them. This can yield maximum fluorescence enhancement. If the bonding energy between the particle and DNA (or any other molecule to be probed) is larger than the average thermal energy (kT), aggregation or loss of nanoparticles during the hybridization or washing processes will be prevented. The tag molecule and the nanoparticle may, in one embodiment, be bridged with a ligand molecule and be attached to the DNA (or any other molecule to be probed, including but not limited to RNA, antibodies, enzymes, factors, cell membrane receptors, proteins or peptides) together. This may be done as long as the bridging molecule blocks charge transfer and prevents quenching of the fluorescence. This will ensure a minimum and well-defined separation between the fluorescent tag and nanoparticle. In these embodiments, the characteristic dimension (diameter in the case of substantially spherical nanoparticles) of the nanoparticles is between about 0.3 nm and about 40 nm. However, it should be noted that this characteristic dimension range is not a limitation of this invention. In these embodiments, the means of detection can be modified to Raman signals.

When the particle size is much smaller than the wavelength of the incident electromagnetic radiation, the electrons in the nanoparticles move in phase. In so doing, they generate an oscillating dipole (or multipole depending on the shape of the particle) that has a resonance condition at a certain frequency (plasmon frequency) at which the amplitude of the oscillating dipole can be excited to a maximum. The plasmon frequency depends on and is tunable by the type of particle material, particle size, shape, and separation, and dielectric constant of the local medium. The plasmon band shifts to lower frequencies (higher wavelengths) and broadens as the particle size is increased, or particle spacing is decreased, or particle aggregation occurs. These variations of the plasmon frequency are responsible for the variation of color seen for metal nanoparticle solutions. The embodiments described herein cover a number of metals and materials and include, but are not limited to, plasmon bands occurring between 1.45 to 4 eV corresponding to 900-350 nm, or near-infrared (NIR) to ultraviolet (UV). For Cu nanoparticles, the plasmon band will tail into more of the NIR, while for Al nanoparticles, the plasmon band is found in the UV. Thus, for a given desired wavelength range of operation, a size and separation range of the nanoparticles of a certain metal or material may be selected in order to produce enhanced local fields for effecting optical response (fluorescence, Raman) enhancement.

In the exemplary embodiments described below, the fluorescent signal intensities of several dyes are enhanced using gold and silver NPs. (The gold and silver NPs have been shown to have SPR absorptions of approximately 510 nm and 420 nm, respectively.) The dyes tested include:

| Fluorescent Dye | Absorbance (nm) | Emission (nm) |
|---|---|---|
| Alexa ® 647 (molecular probes) | 650 | 668 |
| Alexa ® 555 (molecular probes) | 555 | 565 |
| Cy 3 (Amersham Biosciences) | 548 | 562 |
| Cy 5 (Amersham Biosciences) | 646 | 664 |

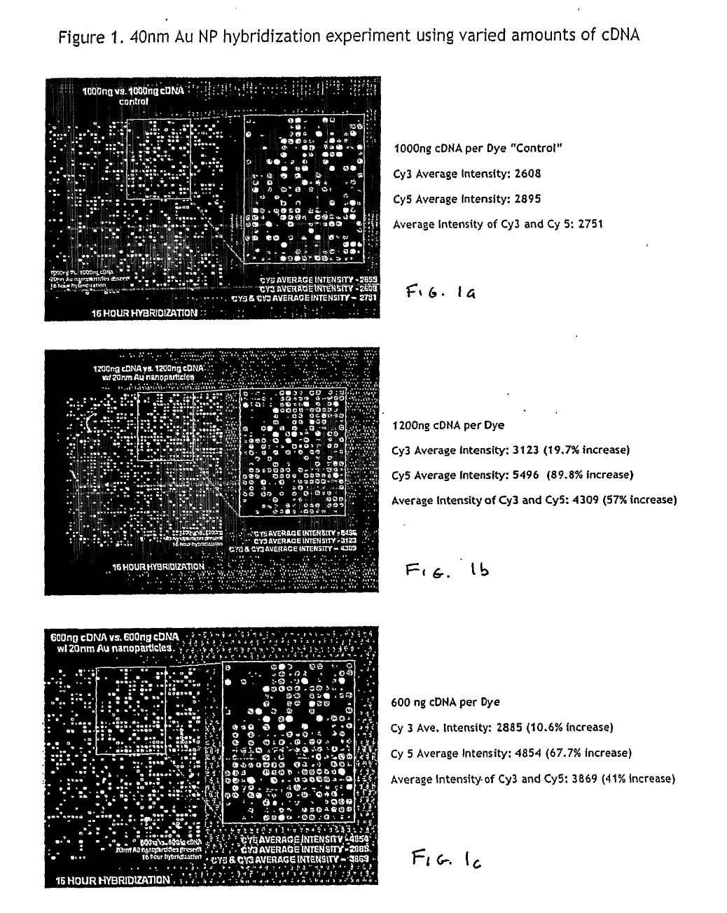

Citrate capped gold and silver colloidal NPs of various diameters (from Ted Pella, Inc, Redding, Calif.) were added to solutions of molecules capable of fluorescing (cDNA having dye molecules attached). The data resulting from this non-reactive functionalized example is shown in FIGS. 1b, 1c. In this example, a self on self hybridization was performed whereby the same cDNA sample is used for both labeling reactions (with Cy3 and Cy5). FIG. 1a shows the signal obtained from using a standard protocol with 1000 ng of cDNA used per labeling reaction. The addition of 20 nm colloidal Au NPs results in an increase in the detected signal (note the “white” signal saturated spots) even though a lesser amount of cDNA (600 ng) was used in each labeling reaction (FIG. 1c). FIG. 1b also shows an increase in signal intensity; however a slightly higher amount of cDNA (1200 ng) was used in each labeling reaction in this case.

The data in FIGS. 1b and 1c illustrate that the addition of colloidal NPs enhances the fluorescent signal.

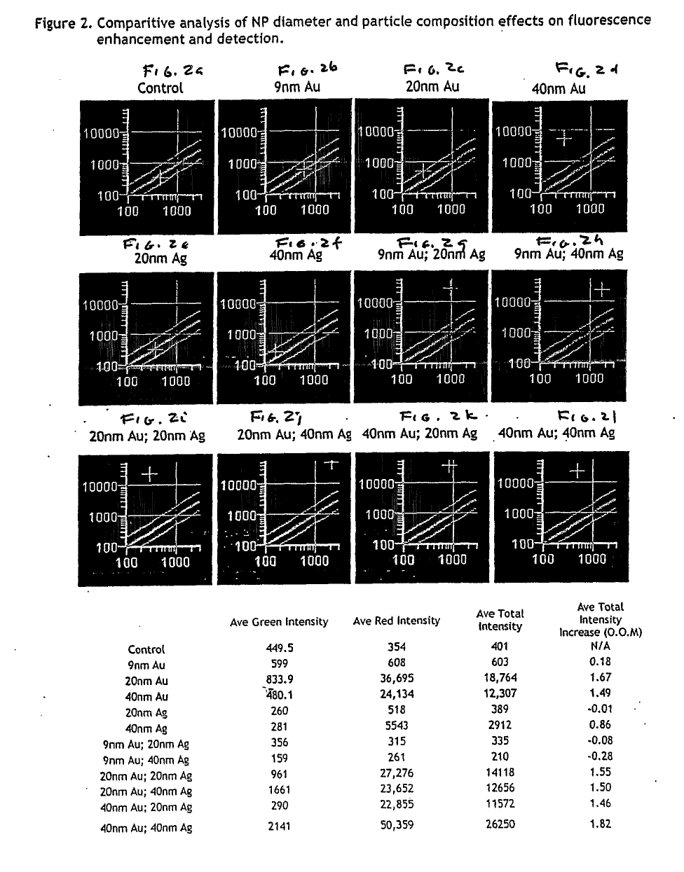

The fluorescence observed with the use of Au or Ag NPs or a mixture of both with various diameters is shown in FIGS. 2b-2l. Taking the average signal intensities in each channel into account the fluorescence enhancement observed with the use of a combination of 20 nm capped Au and 40 nm capped Ag NPs, was shown to give an overall average signal increase of 1.5 orders of magnitude (O.M.).

The data shown in FIGS. 2b-2l illustrates the effects on fluorescence enhancement by the addition of two NPs of different characteristic dimensions, each one of which is thought to interact with a specific fluorophore through specific SPR relationships.

In the example shown in FIGS. 2b-2l, the nanoparticles were added to the solution containing the cDNA probe prior to the hybridization step. The nanoparticles were introduced to target DNA by mixing the Au solution into Cy3/Cy5 dye-coupled cDNA dissolved in a formamide hybridization buffer. The hybridization was carried out for 16 hours. In the data shown in FIGS. 2b-2l, the density of particles and tag molecules (reporting entities) attached to DNA is controlled to optimize the separation between them. Details of the protocol utilized to obtain the result shown in FIGS. 2b-2l are given in Appendix I. The protocol given in Appendix I includes the conventional protocol for incorporating the reporting entity into the cDNA.

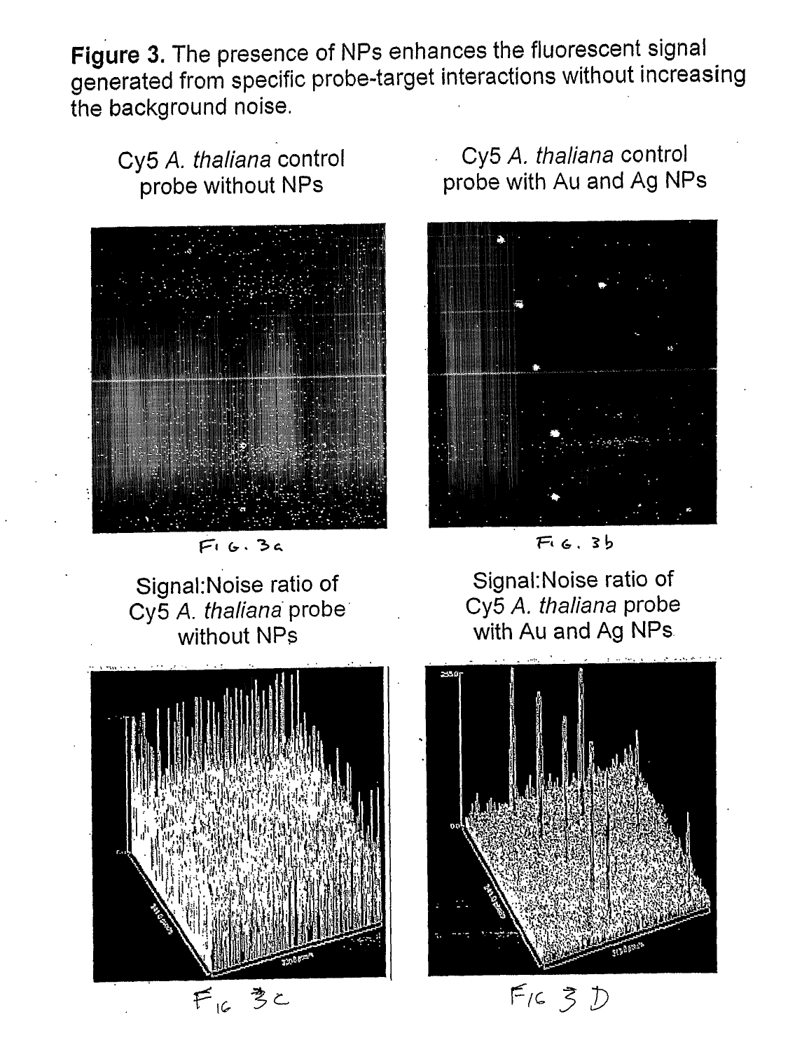

FIGS. 3a-3d depict the fluorescence response obtained using fluorescently labeled Arabidopsis cDNA to probe a human oligonucleotide array in the absence of nanoparticles and in the presence of nanoparticles. FIGS. 3a-3d illustrate the fact that the addition of NPs does not alter the specificity of the probe-target interaction. Fluorescently labeled Arabidopsis cDNA was used to probe a human oligonucleotide array with several Arabidopsis spots embedded into each human sub-array as controls. As can be seen in FIGS. 3a and 3b, the presence of the nanoparticle combination (Au and Ag) enhances the fluorescent signal detected. Furthermore, the presence of NPs had a minimal effect on the specificity of the interaction with only one non-Arabidopsis (human) spot reacting to the Arabidopsis probe. Given the fact that each sub-array contained 400 spots this represents an error rate of 0.25% (FIG. 3). FIGS. 3c and 3d show a representation of the enhancement of the signal to noise ratio seen in this experiment when NPs are incorporated in the reaction.

The data shown above indicate that the addition of the NPs does not skew the types of genes identified and that the NPs will enhance the signal, in the great majority of cases.

In the embodiments described herein below functionalized Reactive (R) NPs were utilized.

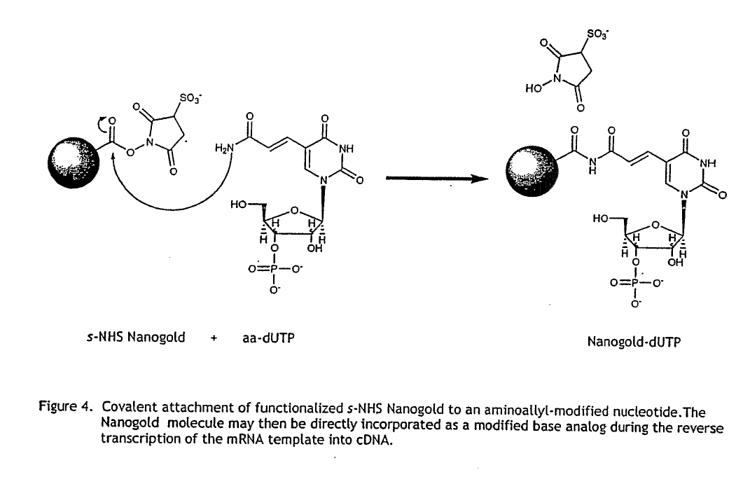

FIG. 4 gives a schematic representation of the mechanism of attachment of reactive functionalized NPs (such as those described in U.S. Pat. No. 5,728,590 and in U.S. Pat. No. 5,521,289, both of which are incorporated by reference herein) to an aminoallyl-modified nucleotide. The functionalized reactive nanoparticle utilized in this embodiment of this invention has been functionalized so that it will attach by substantially the same reaction undergone by the fluorophores during dye coupling to the cDNA. This reaction mechanism, whereby a linking molecule, sulfo-N-hydroxysuccinimide ester (sulfo-NHS) in the embodiment shown in FIG. 4, reacts with a primary amine, is illustrated in simplified form in this figure (FIG. 4). The reactive functionalized nanoparticle shown in FIG. 4 may, in one embodiment, be directly incorporated as a modified base analog doing the reverse transcription of the mRNA template into cDNA.

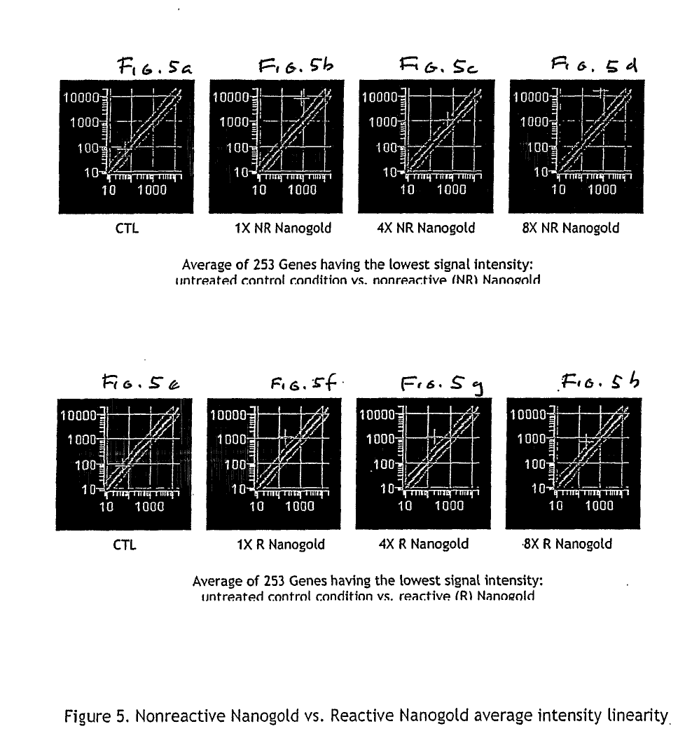

FIGS. 5a-5d depict the fluorescence enhancement observed with the use of gold nanoparticles, which attach to the test molecule by some mechanism, such as vanderwalls bonding. In the embodiment shown in FIGS. 5a-5d, Nanogold® with no reactive group was used as the nanoparticle. Specifically, gold nanoparticles of 1.4 nm diameter were used to obtain the results of FIGS. 5a-5d. It should be noted that this diameter is not a limitation of this invention; nanoparticles of different diameter and compositions can be utilized.

The fluorescence enhancement observed with the use of functionalized reactive NPs, such as those shown in FIG. 4, is shown in FIGS. 5f-5h. (In the embodiment shown in FIGS. 5f-5h, reactive Mono-Sulfo-NHS terminated particles were utilized.) Specifically, functionalized gold nanoparticles of 1.4 nm diameter were used to obtain the results of FIGS. 5f-5h. It should be noted that this diameter is not a limitation of this invention, other diameter and composition nanoparticles can be utilized.

Comparison of the results of FIGS. 5f-5h with the data in FIGS. 5a-5d indicates that the use of functionalized Reactive (R) NPs results in a considerable amelioration of the red shift in the detected signal.

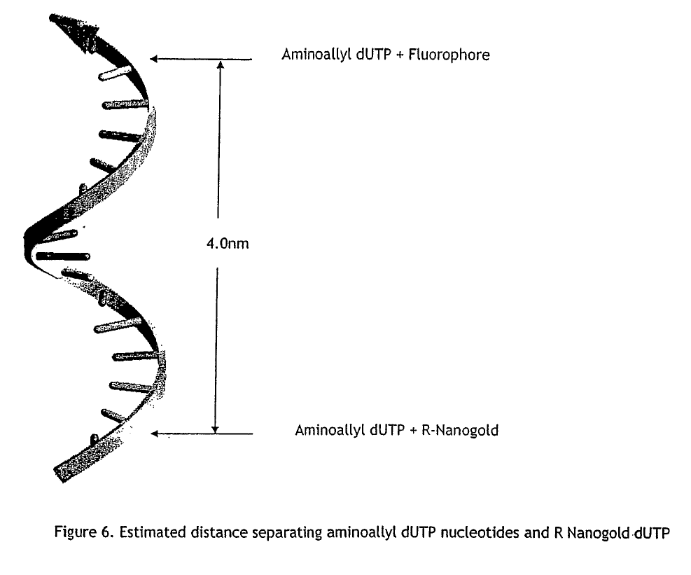

The method of this invention utilized to obtain the embodiment and data shown in FIGS. 5g-5h, (also referred to as competitive incorporation of functionalized reactive NPs) includes the step of adding the functionalized nanogold particles to the reaction at the same time as the fluorescent dye is added. Therefore, both the nanoparticle and the fluorophore “compete” with one another for available binding sites on the cDNA. Protocols used in this embodiment are given in Appendix II. This method of competitively incorporating functionalized reactive NPs and fluorophores in a controlled manner throughout the length of the cDNA molecules shows evidence of reproducible signal enhancement (FIGS. 5g-5h). The data in FIG. 5 also indicate that utilizing functionalized reactive NPs results in an average enhancement of total intensity of 0.91 O.M. (FIG. 5; lower panels); which is less than the observed 1.7 O.M. average enhancement of total intensity obtained from using the Np's functionalized with a non-reactiing surface group (FIG. 5; top panels). However, in the covalent attachment of functionalized reactive NPs, the coupling frequency, or functionalized reactive NPs to functionalized reactive NPs distance, and functionalized reactive NPs to fluorophore distance, can be controlled by simply modifying one reverse transcription ingredient. Computer simulations indicate that the presence of one functionalized reactive NP or fluorophore occurs every 6 to 10 bases, or 2 to 4 nm on average, as shown in FIG. 6. This added control over the reaction afforded by the functionalized reactive NPs contributes to obtaining a very consistent signal and to the lowering of the red shift in the signal.

Genes whose spot intensities are very low in the control condition show intensity increases upon treatment with both NPs, and functionalized reactive NPs (FIGS. 5b-5d, 5f-5h), as was the case with the non-reactive NPs of FIG. 2. However, there is a significant reduction in the red shift present in the signal obtained from arrays in which functionalized reactive NPs were used (FIGS. 5F-5H).

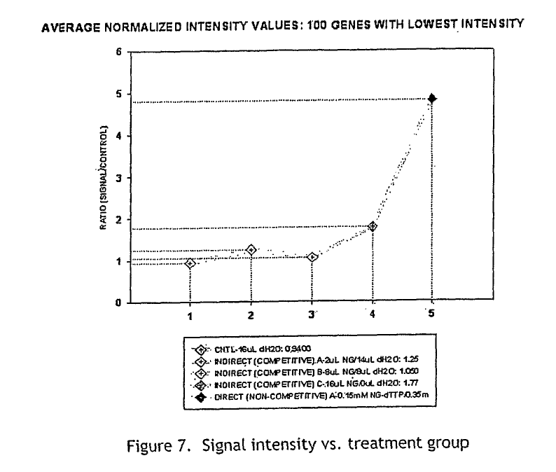

Shown in FIG. 7 are results obtained in simulations where low level gene expression was simulated by using suboptimal amounts of cDNA in the labeling reactions. The signal generated from each of 100 genes having the lowest detectible fluorescent signal intensity was compared in the control condition (FIG. 7; point # 1 on the x-axis), which included no NPs, to the signal generated from the same genes when increasing amounts of functionalized NPs (1×; 4× and 16×) were added in a competitive manner (FIG. 7; points # 2, 3 and 4 on the x-axis respectively). The highest signal intensity observed corresponds to the addition of 16× functionalized NPs (FIG. 7; point # 4 on the x-axis). The results shown in FIG. 7 also indicate that using a direct “non-competitive” approach (see Appendix III), where the functionalized NPs are added to the solution prior to reverse transcription and before the addition of the fluorescent dye, leads to a large enhancement of the signal intensity (FIG. 7; point # 5 on the x-axis).

The “non-competitive” approach is an exemplary embodiment of the method of this invention in which metal nanoparticles are incorporated into a detecting molecule solution and the reporting entity is incorporated into the metal nanoparticle/detecting molecule solution.

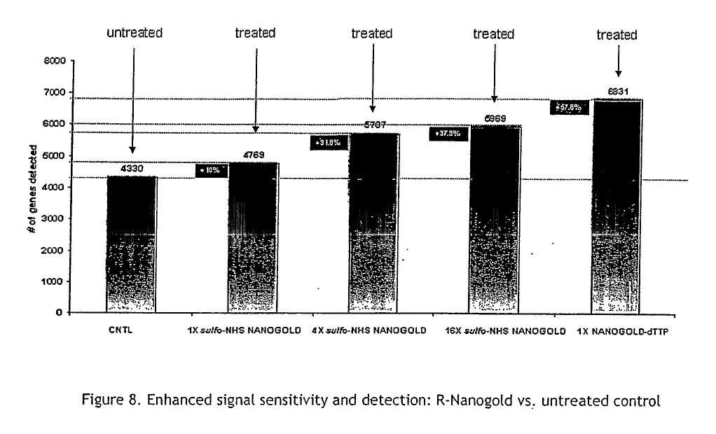

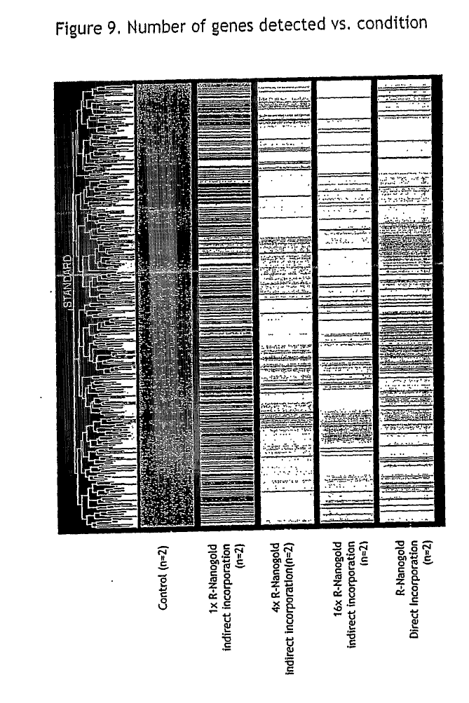

In the results shown in FIG. 7, in the control condition (no NPs) only 4330 genes were detected. The addition of 1× functionalized NPs increased the number of detected genes to 4769 (FIG. 8), at 4× functionalized NPs the number of detected genes became 5707 (FIG. 8) and at 16× functionalized NPS there were 5969 (FIG. 8) genes detected an increase of 37.9% over the control condition. Using the direct non-competitive approach (FIG. 8; 1× nanoparticle labeled dTTP) resulted in the detection of a total of 6831 genes or a 57.8% increase over control (FIG. 8). The same data presented in FIG. 8 is shown using a cluster diagram in FIG. 9. In this figure (FIG. 9) it is easier to visualize the increase in the number genes detected and the intensity of the signal generated from each gene (represented by a horizontal line in each column) under the different conditions.

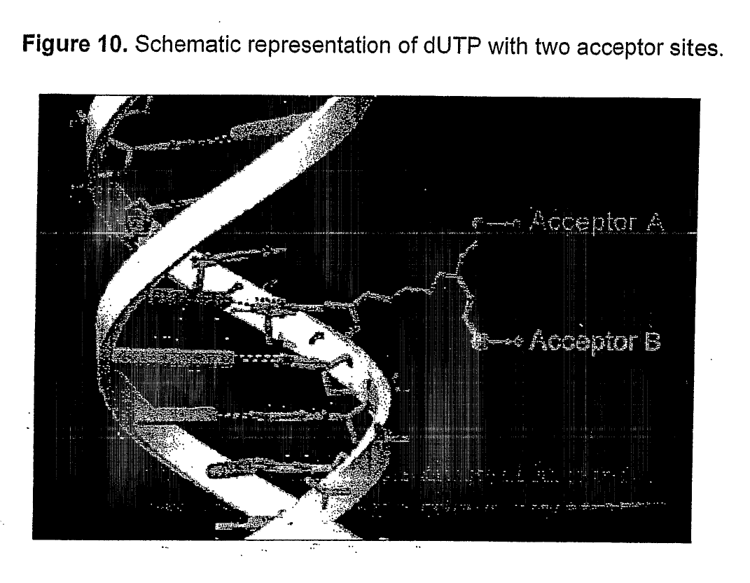

In one embodiment of this invention, fluorophores and nanoparticles can be covalently attached at regular, predictable positions throughout the cDNA probe sequence. One embodiment of the method for this attachment includes constructing a heteroconjugate molecule that consists of a dUTP that has been modified so as to contain an amine modifier in addition to a thiol modifier as two acceptor sites (FIG. 10). The amine modifier will serve as a specific attachment point for the fluorophore molecule, and the thiol modifier will serve as a specific attachment point for a nanoparticle. The only impact upon existing labeling protocols would be the exchange of conventional amino allyl-dUTP with this novel bifunctional dUTP, and the addition of functionalized nanoparticle reactive to the thiol group. Minor adjustments to the composition of this bifunctional dUTP enable accurate and reliable attachment of known amounts of fluorophore and nanoparticle to the cDNA probe, and more accurate control of the distance between each nanoparticle and fluorophore molecule.

The enhanced fluorescence observed from molecules in the close vicinity of metal nanoparticles is attributable to the enhanced absorption of the light excitation as well as the enhanced emission rate as a result of enhanced near fields. Another advantage of the enhanced emission rate is a decrease in photobleaching resulting from a shortening of the characteristic time a fluorescent molecule spends at the excited state.

It should be noted that, although this invention was described above in terms of embodiments in which the detecting molecule was cDNA, the reporting entity was a fluorophore, and the detection signal was fluorescence, these are not limitations of this invention, as explained above, and other embodiments are within the scope of this invention.

Although the invention has been described with respect to various embodiments, it should be realized this invention is also capable of a wide variety of further embodiments within the spirit and scope of the of the appended claims.

### APPENDIX I

1. cDNA Synthesis

The synthesis of cDNA from the mRNA extracted from lysed cells or obtained commercially was accomplished through reverse transcription. This process was performed by adding 5 μg of total RNA dissolved in ddH₂O and Oligo-d(T)20 Primers to a sterile microcentrifuge tube.

Additional nuclease-free water was added to bring the final volume within the tube to 15.5 μL. The tube was then incubated at 75° C. for 8 minutes and at the conclusion of this time it was immediately placed on ice for 1 minute to allow for the primers to bind to the appropriate sites on the mRNA strand.

After the incubation period, the following reagents were then added to the microcentrifuge tube: 3 μL of StrataScript Buffer, 10× (Stratagene, CA); 2 μL of aa-dNTP mix, 50×; 2 μL of StrataScript RT (50 U/μL) (Statagene, CA) and 8.9 μL of nuclease-free H2O. The aa-dNTP mixture is an aqueous solution containing 10 μL of the following nucleotides which the cDNA is constructed of: dATP, dCTP, and dGTP, each at a concentration of 100 mM. In addition 6 μL of dTTP and 3 μL of amine-allyl conjugated dUTP (aa-dUTP), both at 100 mM concentration, were added to the mix. The amine-allyle group will be utilized later to link a fluorochrome to the cDNA as a means for detecting the presence of cDNA following hybridization. The microcentrifuge tube containing the aforementioned reagents was incubated at 42° C. for 1 hour. After this time, 1 μL of StrataScript RT was added to the tube and the solution was incubated for an additional hour. A solution containing 1 μL of 0.5M EDTA and 3.2 μL of 1M NaOH was then added to tube and the solution was incubated at 68° C. for 10 minutes in order to terminate the reaction and degrade the RNA.

2. Isolation and Concentrating of cDNA

The synthesized Complementary DNA was then isolated and concentrated through the use of Zymo Clean & Concentrator-5™ columns (Zymo Research, CA). In brief, 1 mL of Zymo DNA binding buffer (Zymo Research, CA) was added to a sterile microcentrifuge tube. The solution containing the cDNA to be purified is added to the tube and gently mixed by inverting the tube several times. This solution was then added to a Zymo Clean and Concentrator-5™ column with a collection tube attached to the bottom and was spun in a centrifuge at 5,000 rpm. The eluted solution was disposed of and 600 μL of Zymo Wash Buffer (Zymo Research, CA) was added to the column. The column was spun at 5,000 rpm for 1 minute and the solution collected in the tube was discarded. This step was repeated to remove any residual wash solution from the column. The column was then placed in an appropriately labeled sterile microcentrifuge tube and 8 μL of dH2O was added to the column. The column was allowed to sit for approximately 30 seconds before being placed in the centrifuge and spinning the sample at 14,000 rpm for 30 seconds. An additional 6 μL of dH2O was added to the column. After waiting 30 seconds the column was centrifuged at 14,000 rpm for one minute. The eluted solution contains the purified cDNA in 14 μL of dH2O.

### 3. Dye Coupling

Following the synthesis of cDNA, it was necessary to tag the cDNA with some sort of marker that will allow for its detection later. The method utilized to accomplish this task was by attaching fluorochromes to the amine-allyl functionalized uracilnucleotides. The fluorochrome is functionalized with a n-hydroxysyccinimidyl ester side group that will react with free primary amine groups present on the amine-allyl, covalently linking the fluorophore to the cDNA. This was performed by initially resuspending the dehydrated fluorescent dye in 2 μL of dimethyl sulfoxide (DMSO). The 14 μL solution of aa-cDNA prepared earlier was further concentrated to a volume of 5 μL using a centrifugal evaporator to which 3 μL of 300 mM NaHCO3 was added, which will act as a coupling buffer. The solution containing the probe cDNA was then added to the Alexa dye, mixed thoroughly, and allowed to incubate in the dark at room temperature for one hour. After the incubation period, the cDNA was separated from the uncoupled dye through use of Zymo Clean & Concentrator-5™ column and conventional protocols.

4. cDNA Hybridization to Microarray

Once the cDNA probe is coupled with the appropriate fluorescent dye, it was ready for exposure to a microarray for examination of gene expression within that particular sample of cells. First, the cDNA probe from the experimental sample and that from the control were thoroughly mixed and the volume of this solution was then concentrated to 15.5 μL using a centrifugal evaporator. A solution containing 2.9 μL of 20×SSC (Sigma, Mo.), 0.4 μL 1M Hepes at pH of 7 (Sigma, Mo.), and 0.4 μL 10% SDS (Sigma, Mo.) was then added to the tube containing the probe.

This mixture was heated for 2 minutes at 100° C. to denature all the strands of DNA and then cooled by incubating on ice for a period of time not exceeding 3 minutes. During this time the array was prepared by first using a stream of compressed air to blow any particulates off the surface to ensure that the surface of the array was both clean and dry.

A Gene Frame® (MWG, Germany) was then carefully fitted over the spotted area on the array. The citrate terminated Au Colloids were added to the solution containing the probe. At this point the mixture containing the probe was then dispensed at one end of the frame using a pipette. A polyester cover slip, provided with the Gene Frame®, was positioned over the frame and was carefully brought into contact with the adhesive frame starting over the area where the probe solution was initially added and gradually working to the opposite end of the frame. The arrays were then sealed in hybridization chambers (Corning, N.Y.) and then incubated at 43° C. for approximately 19 hours. During this time the tagged cDNA probes will preferentially hybridize to the complementary sequence of DNA, referred to as the target, bound to the surface of the array.

5. Post-Hybridization Washing Procedure At the conclusion of the hybridization step, the Gene Frames® were carefully removed and the arrays were exposed to a series of wash solutions to rinse any non-hybridized probe from the surface of the array. This washing process is also meant to remove any residual salt that may remain on the surface of the array from the hybridization process. Significant salt deposits on the array could interfere with detecting the presence of the fluorescently labeled cDNA probe hybridized to the array due to the ability of salt crystals to autofluoresce, leading to high background to signal ratio.

Following the removal of Gene Frame®, the arrays were immediately placed in a bath of 2× (SSC) with 0.1% (SDS) that was pre-warmed to 30° C. The bath was placed on an orbital shaker to provide moderate agitation while in the wash solution. The array was washed for 5 minutes in the dark and then transferred to the next wash solution. This wash process was then repeated two more times, first using a solution of 1×SSC and then 0.5×SSC. The arrays were then placed in a 50 mL conical centrifuge tube and dried by briefly spinning within a centrifuge.

### 6. Scanning and Analysis

The detection and quantification of fluorescently labeled probes bound to the surface of the array was done using a ScanArray Express, microarray scanner (Packard BioScience, MA) equipped with both 543 nm and 633 nm argon lasers. This system utilized a fixed laser source and confocal optics, with beam splitter and emission filters, to scan arrays that were mounted on a motorized stage controlled by the system. The 543 nm wavelength laser was used to excite probes coupled with Alexa Fluor® 546 (Molecular Probes, OR). Emitted light was passed through a 570 nm wavelength high pass emission filter before reaching the detector to eliminate any reflected laser light from interfering with signal detection. Alexa Fluor® 660 (Molecular Probes, OR) coupled probes were excited using the 633 nm wavelength laser while the emitted light was passed through a 670 nm wavelength high pass emission filter. All arrays were scanned at a 10 micrometer resolution and the data collected was analyzed using GeneSpring (Silicon Genetics, CA), a type of microarray analysis software.

APPENDIX II
ALEXA FLUOR aa-cDNA PROBE REVERSE
TRANSCRIPTION PROTOCOL
5OX dNTP/aa-dUTP

| | | |
|---|---|---|
| 100 mM dATP | 10 | uL |
| 100 mM dGTP | 10 | uL |
| 100 mM dCTP | 10 | uL |
| 100 mM dTTP | 3 | uL |
| 100 mM aa-dUTP | 6 | uL |
| Priming reaction/total RNA | | |
| Random hexamer/oligo dT primer | | |
| Qiagen: add 15 uL dH2O to SP200, and 5D uL to SP230 | | |
| SP200 (random hexamer) | 2 | ug/ul |
| SP230 (oligo-dT) | 2 | ug/ul |

| | vol/rxn | |
|---|---|---|
| total RNA(≧5 ug) | x | ul |
| oligo dT primer (2 ug/uL) | 1.0 | ul |
| random N⁶ primer (2 ug/uL) | 1.0 | ul |
| dNTP + aa-dUTP2:1 | 0.6 | ul |
| H20, nuclease-free | 15.5 − (2.6 + x) | ul |
| | 15.5 | ul |

Incubate the priming reaction(s) at 75° C. for 8 min to linearize the secondary structure. Remove and put on ice.

Set Heat Block to read 50° C. on a thermometer. Set up the cDNA synthesis reaction master mix. Make a slight excess amount of Master Mix (MM) to ensure a full aliquot of 14.5 ul is available for each reaction (e.g. doing 2 reverse transcription reactions, make master mix for 2.5 reactions). Vortex master mix well to ensure mixing!

| | Vol/rxn | | X Rxns = Total For MM |
|---|---|---|---|
| StrataScript Buffer, 10X | 3.0 | ul | |
| RNAse inhibitor | 1.0 | ul | |
| DTT | 1.0 | ul | |
| SuperScript III RT (200 U/ul) | 1.5 | ul | |
| H20. nuclease-free | 8.0 | ul | |
| | 14.5 | ul | |

Add master mix to each priming reaction. Use 14.5 ul of the MM for each reaction.

Incubate the reactions@50 C for 2 hours.

Spin briefly in the mocrocentrifuge to collect contents at the bottom of the tube. Set Heatblock to read 70 C on a thermometer.

To degrade the RNA after cDNA synthesis, add the following IN ORDER to each r×n:

(1) 10.0 ul of 0.5 M EDTA

(2) 10.0 ul of 1.0 M NaOH

Mix well. Spin briefly to collect contents. Incubate@70° C. for 10 min on the heatblock.

Add 45 OuL of nuclease-free H₂0 to sample, then place the 5 OOuL sample volume into a Millipore Microcon 30 column. Spin for 10 minutes at 13000 rpm.

Discard the flow-through, and repeat steps 8 and 9 one more time, making sure not to spin to completion.

Place filtration unit upside-down in a fresh tube to collect sample during a two minute spin.

Note. cDNA is now ready for dye coupling. This product can be stored at −20 C indefinitely. To be sure the cDNA synthesis went well, test 1 uL cDNA reaction by running on the Agilent bioanalyzer.

Sulfo-N-Hydroxy-Succlnimido Nanogold® & Alexa Fluor Indirect, Competitive Incorporation to Amine. Modified cDNA

### Prepare Labeling Buffer

Make up a solution of 25 mg of sodium bicarbonate in 1 mL of nuclease-free H20 and vortex the solution until the solid is completely dissolved, Store the Labeling Buffer at −20 C in single-use aliquots. When properly stored, Labeling Buffer should be stable for at least 6 months.

### Add Labeling Buffer to the Amine-Modified DNA.

Add 3 μL of Labeling Buffer to the amine modified DNA.

### Nanogold and Alexa Preparation

Dissolve each Alexa dye in 2 ul DMSO.

Dissolve the mono-sulfo-NHS-NANOGOLD reagent in 200 ul deionized water. Use 5 nmol NG reagent to label 1 nmol of amine sites. The succinimide ester is hydrolyzed in aqueous solution. To ensure better solution, dissolve in a small amount (up to 20% of final solution) of dimethyl sulfoxide (DMSO), then make up to 100% with water. If the reagent is still slow to dissolve, the solution may be vortexed

Add the activated NANOGOLD® solution to each Alexa 555 & 647 dye.

The extent of labeling may be calculated from the UV-visible spectrum of the conjugate. Sulf0-succinimido-NANOGOLD® has extinction coefficients at 280 nm of 2.3×10⁵ M⁻¹ cm⁻¹ and at 420 nm of 1.1×10⁵ M⁻¹ cm⁻¹.

### Add Amine-Modified DNA to the Reactive Dyes

Add the 8 μL of the amine-modified DNA to each dye. Vortex briefly to ensure that the reaction is well mixed. DO NOT spin the tube to collect the solution in the bottom of the tube, but instead, let it settle by gravity.

### Incubate.

Leave the reaction in the dark at room temperature for 1-2 hours.

### Removal of Uncoupled Dye Material

The QiaQuick (Qiagen) PCR Purification columns work well for removal of uncoupled dye. Purify each dye labeled sample separately by following the manufacturers directions with the following modifications:
Mix in Buffer B (5OOμL) with the coupling reaction before application to the DNA binding column.
Rinse the column with 600 μl of Buffer PE at least two times.
After the final rinse, spin the column one more additional time to remove any traces of the rinse buffer.
Add 60 μL of elution Buffer EB to the column and let incubate for 5 minutes at room temperature. Spin eluate through to a collection tube.
Repeat the elution with another 60 μL of Buffer EB.
Concentrate the eluate to 20 uL using a Microcon-30 spin filter.

QiAQUICK PCR PURIFICATION KIT PROTOCOL using a microcentrifuge (QiAquick Spin Handbook 0712002)

This protocol is designed to purify single- or double-stranded DNA fragments from PCR and other enzymatic reactions. For cleanup of other enzymatic reactions, follow the protocol as described for PCR samples or use the new MinElute Reaction Cleanup Kit. Fragments ranging from 100 bp to 10 kb are purified from primers, nucleotides, polymerases, and salts using QiAquick spin columns in a microcentrifuge.

Notes:
Add ethanol (96-100%) to Buffer PE before use (see bottle label for volume).
All centrifuge steps are-at 13,000 rpm (−17,900×g) in a conventional tabletop microcentrifuge.

Combine both coupling reactions together, and add 500 ul Buffer B.

1. Add 5 volumes of Buffer PB to 1 volume of the PCR sample and mix,

2. Place a QiAquick spin column in a provided 2 ml collection tube.

3. To bind DNA, apply the sample to the QIAquick column and centrifuge for 30-60 s

4. Discard flow-through. Place the QIAquick column back into the same tube.

5. To wash, add 0.60 ml Buffer PB to the QIAquick column and centrifuge for 30-60 s. Repeat

6. Discard flow-through and place the QIAquick column back in the same tube. Centrifuge the column for an additional 1 min. IMPORTANT:Residual ethanol from Buffer PB will not be completely removed unless the flow-through is discarded before this additional centrifugation.

7. Place QiAquick column in a clean 1.5 ml microcentrifuge tube,

8. To elute DNA, add 60 μl Buffer EB (10 mM Tris Cl, pH 8.5) or H₂0 to the center of the QiAquick membrane and centrifuge the column for 1 min. Repeat.

Elution efficiency is dependent on pH. The maximum elution efficiency is achieved between pH 7.0 and 8.5. When using water, make sure that the pH value is within this range, and store DNA at −20*C as DNA may degrade in the absence of a buffering agent. The purified DNA can also be eluted in TE (10 mM Tris Cl, 1 mM EDTA, pH 8.0), but the EDTA may Inhibit subsequent enzymatic reactions.

### Hybridization B—Lifter-Slips®

Pre-Calculated Values for Lifter-Slip Hybridization Volumes

| Component | 22 mm × 25 mm | | 60 mm × 25 mm | | Other |
|---|---|---|---|---|---|
| Probe in H20 | 15.5 | uL | 40.2 | uL | |
| Poly A (Optional) | 0.0 | uL | 0.0 | uL | |
| 20X SSC | 2.9 | uL | 9.3 | uL | |
| 1M Hepes, pH = 7.0 | 0.4 | uL | 1.3 | uL | |
| 10% SDS | 0.4 | uL | 1.3 | uL | |
| Total Volume. | 19.2 | uL | 52.1 | uL | |

1. Boil probe for 2 minutes at 100 C (use lid retainer clips). This denatures the sample, allowing it to hybridize to the target. Snap freeze for 30 seconds.

2. Use a bulb or compressed air to blow dust/debris off the hybridization area on each array.

3. Clean a Lifter-Slip with 100% ElOH, and wipe clean using a Kim-Wipe.

4. Place the appropriate lifter slip over the hybridization area.

5. Slowly inject the entire hybridization volume under one corner of the lifter slip.

6. Place the array in an appropriate hybridization chamber, and pipette enough 3×SSC into the chamber to ensure that the array does not dry out during incubation.

7. Close the Hybridization chamber, and incubate at 42-44 C for 18-24 hours.

### APPENDIX III

### Microarray Protocol

### Direct Incorporation of Sulfo-NHS Nanogold=Non-Competitive

Alexa Fluor aa-cDNA Probe Reverse Transcription Protocol

NG-dTTP Note. dTTP was omitted from the dNTP mix and replaced with the reacted Nanogold-aminoallyl dUTP conjugate, (dTTP and dUTP are functionally identical)

### Prepare Labeling Buffer

Make up a solution of 25 mg of sodium bicarbonate in 1 mL of nuclease-free H₂0 and vortex the solution until the solid is completely dissolved. Store the Labeling Buffer at −20′C in single-use aliquots. When properly stored, Labeling Buffer should be stable far at least 6 months.

### Add Labeling Buffer to the Amino-Modified DNA,

Add 3 μL of Labeling Buffer to the amine modified DNA. Dissolve the mono-sulfo-NHS-NANOGOLD reagent in 200 ul deionized water. Use 5 nmol NG reagent to label 1 nmol of amine sites. The succinimide ester is hydrolyzed in aqueous solution. To ensure better solution, dissolve in a small amount (up to 20% of final solution) of dimethyl sulfoxide (DMSO), then make up to 100% with water. If the reagent is still slow to dissolve, the solution may be vortexed.

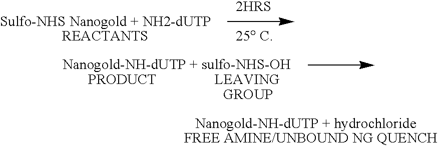

5OX dNTP/aa-dUTP

| | | |
|---|---|---|
| 100 mM dATP | 10 | uL |
| 100 mM dGTP | 10 | uL |
| 100 mM dCTP | 10 | uL |
| NG-dTTP | 3 | uL |
| 100 mM aa-dUTP | 6 | uL |

Priming reaction/total RNA
Random hexamer/oligo dT primer
Qiagen: add 15 uL dH2O to SP200, and 5 DuL to SP230

| | |
|---|---|
| SP200 (random hexamer) | 2 ug/ul |
| SP230 (oligo-dT) | 2 ug/ul |

| | |
|---|---|
| Priming reaction/total RNA | vol/rxn |

| | | |
|---|---|---|
| total RNA (≧5 ug) | x | ul |
| oligo dT primer (2 ug/uL) | 1.0 | μl |
| random N6 primer (2 ug/uL) | 1.0 | μl |
| dNTP + aa-dUTP/NG-dTTP_{2:1} | 0.6 | μl |
| H20, nuclease-free | 15.5 − (2.6 + x) | μl |
| | 15.5 | μl |

Incubate the priming reaction(s) at 75′C for 8 min to linearize the secondary structure. Remove and put on ice. Set Heat Block to read 50 C on a thermometer.

What is claimed is:

1. A system comprising:
at least one metal nanoparticle;
at least one reporting entity;
a detecting molecule solution into which the at least one reporting entity and the at least one metal nanoparticle are incorporated;
said at least one reporting entity being capable of being also bound/incorporated to at least one molecule in the detecting molecule solution;
said at least one metal nanoparticle being capable of being bound/incorporated to said at least one molecule in the detecting molecule solution at a location different from a location at which said reporting entity is bound/incorporated to said at least one molecule in the detecting molecule solution;
whereby said at least one metal nanoparticle enhances a signal due to said reporting entity.

2. The system of claim 1 wherein the at least one reporting entity and the at least one metal nanoparticle are incorporated by attaching said at least one reporting entity and the at least one metal nanoparticle to said at least one molecule in the detecting molecule solution.

3. The system of claim 1 wherein said at least one metal nanoparticle is bonded to said at least one detecting molecule by Van der Waals, ionic, hydrogen, or covalent bonding.

4. The system of claim 1 wherein said at least one metal nanoparticle comprises at least two metal nanoparticles, said at least two metal nanoparticles having different characteristic dimensions.

5. The system of claim 1 wherein said at least one metal nanoparticle comprises at least one functionalized metal nanoparticle.

6. The system of claim 5 wherein said at least one functionalized metal nanoparticle attaches to the at least one molecule by substantially the same reaction undergone by the reporting entity during attachment to the detecting molecule.

7. The system of claim 1 wherein said at least one metal nanoparticle comprises at least two metal nanoparticles, said at least two metal nanoparticles having different composition.

8. The system of claim 1 where the at least one reporting entity and the at least one metal nanoparticle are incorporated by attaching at least one metal nanoparticle to at least one molecule in the detecting molecule solution, and, subsequently attaching, at a different location, said at least one reporting entity to said at least one molecule in the detecting molecule solution having at least one metal nanoparticle attached therein.

9. The system of claim 1 where the at least one reporting entity and the at least one metal nanoparticle are incorporated by attaching at least one reporting entity to at least one molecule in the detecting molecule solution and, subsequently attaching, at a different location, said at least one metal nanoparticle to said at least one molecule in the detecting molecule solution.

10. A method for enhancing a sensing signal, the method comprising the step of:
incorporating metal nanoparticles and reporting entities into a detecting molecule solution;
the metal nanoparticles being capable of being incorporated to molecules from the detecting molecule solution at a location different from a location at which the reporting entities are incorporated to molecules from the detecting molecule solution;
whereby the metal nanoparticles enhance the signal due to the reporting entities.

11. The method of claim 10 wherein the detecting molecule solution is a nucleic acid solution and the reporting entities are fluorophores or Raman scattering entities.

12. The method of claim 10 further comprising the step of: modifying at least one detecting molecule from said detecting molecule solution in order to enable attachment of at least one metal nanoparticle and at least one reporting entity to said at least one detecting molecule, said modification enabling attachment of said at least one metal nanoparticles and said at least one reporting entity at different locations.

13. A method for enhancing a signal, the method comprising the steps of:
incorporating metal nanoparticles into a detecting molecule solution;
incorporating a reporting entity into the metal nanoparticle/detecting molecule solution;
the metal nanoparticles being capable of being incorporated to molecules from the detecting molecule solution at a location different from a location at which the reporting entities are incorporated to molecules from the detecting molecule solution;
whereby the metal nanoparticles enhance the signal due to the reporting entity.

14. The method of claim 13 wherein the detecting molecule solution is a nucleic acid solution and the reporting entity is a fluorophore or Raman scattering entity.

15. A method for enhancing a signal, the method comprising the steps of:
incorporating a reporting entity into a detecting molecule solution;
incorporating metal nanoparticles into the reporting entity/detecting molecule solution;
the metal nanoparticles being capable of being incorporated to molecules from the detecting molecule solution at a location different from a location at which the reporting entity is incorporated to molecules from the detecting molecule solution;
whereby the metal nanoparticles enhance the signal due to the reporting entity.

16. The method of claim 15 wherein the detecting molecule solution is a nucleic acid solution and the reporting entity is a fluorophore or Raman scattering entity.

17. A method for enhancing fluorescence from molecules, the method comprising the steps of:
dispersing metal nanoparticles in a solution including molecules capable of fluorescing or of a Raman signal; and,
attaching the metal nanoparticles to the molecules;
the metal nanoparticles being separated from a fluorescing or Raman signaling portion of the molecules;
whereby the metal nanoparticles enhance the fluorescence or Raman signal.
